(19) United States
(12) Patent Application Publication
(10) Pub. No.: US 2006/0037995 A1
(43) Pub. Date: Feb. 23, 2006

(54) Heatslug to leadframe attachment

(75) Inventor: Bernhard P. Lange, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/923,654

(22) Filed: Aug. 20, 2004

(51) Int. Cl. B23K 31/02

(52) U.S. Cl. 228/179.1

(57) ABSTRACT

A method for coupling a heat slug to a lead frame, comprising aligning a heat slug and a lead frame depositing a material between the heat slug and the lead frame, and clamping together the heat slug and the lead frame.

### BACKGROUND

During a semiconductor packaging process, an integrated circuit (“IC”) is mounted inside a plastic mold compound (“package”). Various points on the IC are electrically connected to lead frames circumscribing the package using bond wires. In turn, the lead frames circumscribing the package are electrically connected to an application board, such as a printed circuit board (“PCB”). In this way, multiple electrical connections are established between the IC and the PCB. For example, FIG. 1a shows a top view of an IC 100 electrically connected to lead frame 102 of a package 104 using bond wires 106. The lead frame 102 is electrically connected to a PCB 108, thereby establishing multiple electrical connections between the IC 100 and the PCB 108.

The IC 100 abuts a heat slug 200 that is used to conduct heat away from the IC 100 and out of the package 104. During a packaging process, the heat slug 200 is coupled to the lead frame 102 using a riveting technique, wherein the heat slug 200 is punched through apertures 202 in the lead frame 102 and flattened on the opposite side of the lead frame 102, as shown in FIG. 1b. In this way, the heat slug 200 is held abutting the lead frame 102.

However, this time-consuming riveting technique requires the use of a riveting machine, which adds to the cost of the manufacturing process. Furthermore, the mechanics of the riveting machine require the riveting process to be performed prior to package assembly. For this reason, during package assembly, the riveted lead frame 102 and heat slug 200 are fixed in place. Thus, the package 104 is limited in size and design flexibility.

### SUMMARY

The problems noted above are solved in large part by a clamping technique that couples a heat slug to a lead frame without the use of a clamping machine. One exemplary embodiment may be a method for coupling a heat slug to a lead frame, comprising aligning a heat slug and a lead frame, depositing a material between the heat slug and the lead frame, and clamping together the heat slug and the lead frame.

### BRIEF DESCRIPTION OF THE DRAWINGS

For a detailed description of exemplary embodiments of the invention, reference will now be made to the accompanying drawings in which:

FIG. 1a shows a top vie of a printed circuit board (“PCB”) abutting a leaded package;

FIG. 1b shows a cross sectional side view of a lead frame coupled to a heat slug using a riveting technique;

FIGS. 2a-2d show a cross sectional side view of a lead frame and a heat slug coupled using the clamping technique, in accordance with embodiments of the invention;

FIG. 3 shows a flow diagram of a process that may be used to implement the configurations of FIGS. 2a-2d, in accordance with embodiments of the invention;

FIGS. 4a-4d show a cross sectional side view process flow of a lead frame and a heat slug coupled using the clamping technique, in accordance with embodiments of the invention;

FIG. 5 shows a flow diagram of a process that may be used to implement the configurations of FIGS. 4a-4c, in accordance with embodiments of the invention;

FIGS. 6a-6c show a cross sectional side view process flow of a lead frame and a heat slug coupled using the clamping technique, in accordance with embodiments of the invention; and

FIG. 7 shows a flow diagram of a process that may be used to implement the configurations of FIGS. 6a-6c, in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

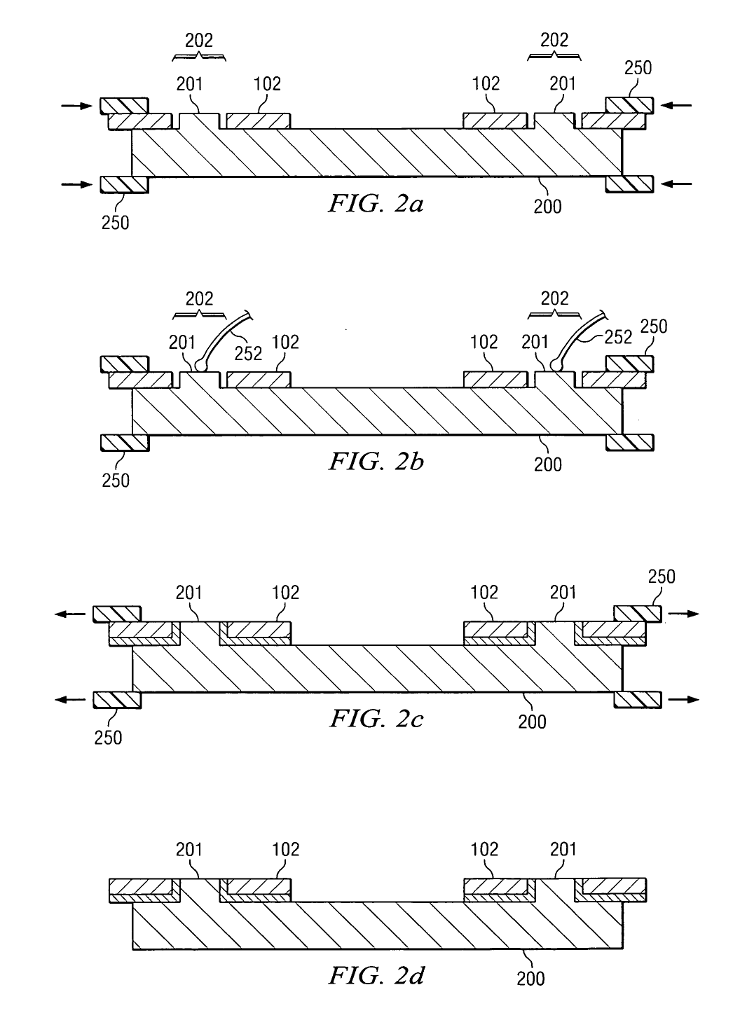

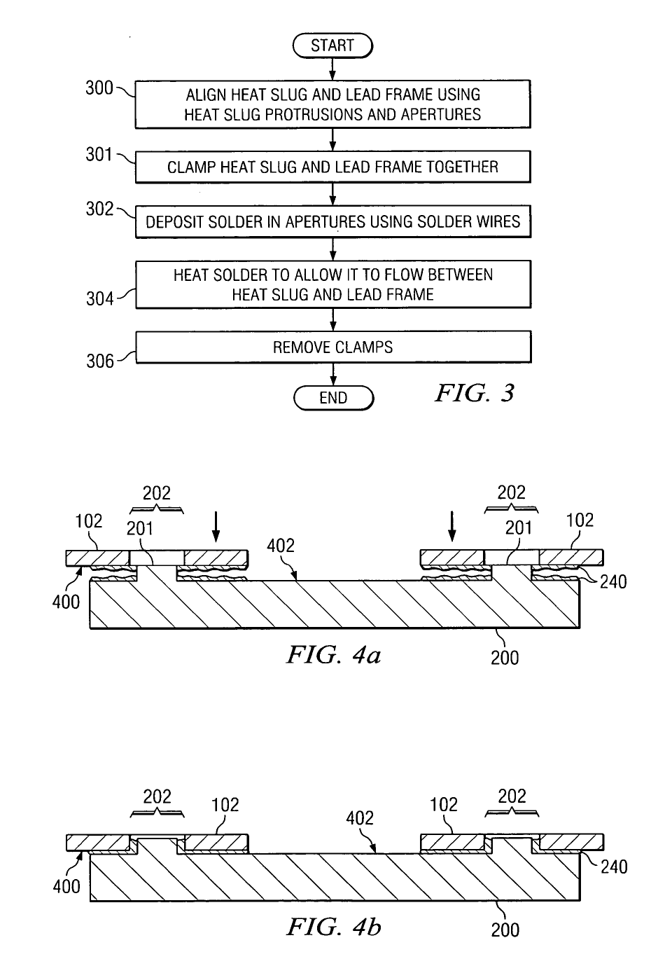

Presented herein is a clamping technique that couples a heat slug to a lead frame without the use of a riveting machine. FIGS. 2a-2d show a lead frame 102 being electrically coupled to a heat slug 200 using an exemplary embodiment of the clamping technique. FIG. 3 shows a process that may be used to implement the configurations shown in FIGS. 2a-2d. Specifically, FIG. 2a shows a lead frame 102 aligned adjacent a heat slug 200. The lead frame 102 and the heat slug 200 are aligned by mating heat slug protrusions 201 and the apertures 202 (block 300). The heat slug 200 and the lead frame 102 are aligned to ensure compliance with design specifications. For example, design specifications may require that the heat slug 200 be positioned at a specific point in relation to the lead frame 102. The heat slug protrusions 201 and the apertures 202 ensure that this positioning requirement is satisfied. The heat slug protrusions 201 and the apertures 202 preferably are substantially round in shape, although the protrusions 201 and the apertures 202 also may be any other suitable shape (e.g., rectangular, triangular).

The lead frame 102 then is held abutting the heat slug 200 with one or more clamps 250 (block 301). As shown in FIG. 2b, solder wires 252 are used to deposit solder into the apertures 202 (block 302). Heating the lead frame 102 and the heat slug 200 causes the solder to melt and fill the apertures 202. Although spaces between the heat slug 200 and the lead frame 102 are substantially narrow, a capillary effect causes the melted solder to flow between the heat slug 200 and the lead frame 102, thereby electrically coupling the lead frame 102 and the heat slug 200, as shown in FIG. 2c (block 304). The clamps then may be removed, as shown in FIG. 2d (block 306). The IC 100 (not shown) optionally may be coupled to the heat slug 200 using solder from the solder wires.

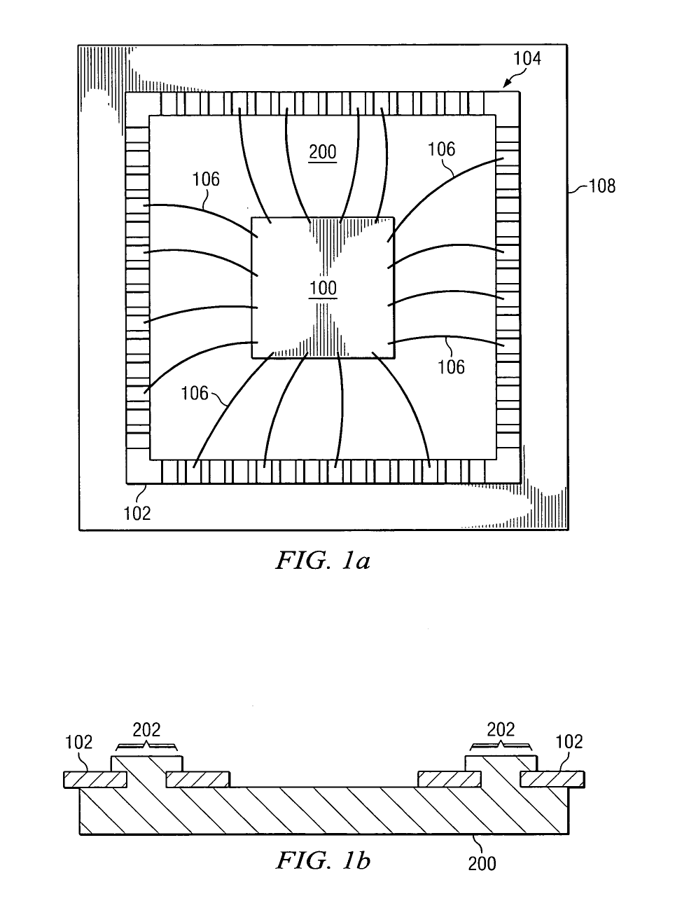

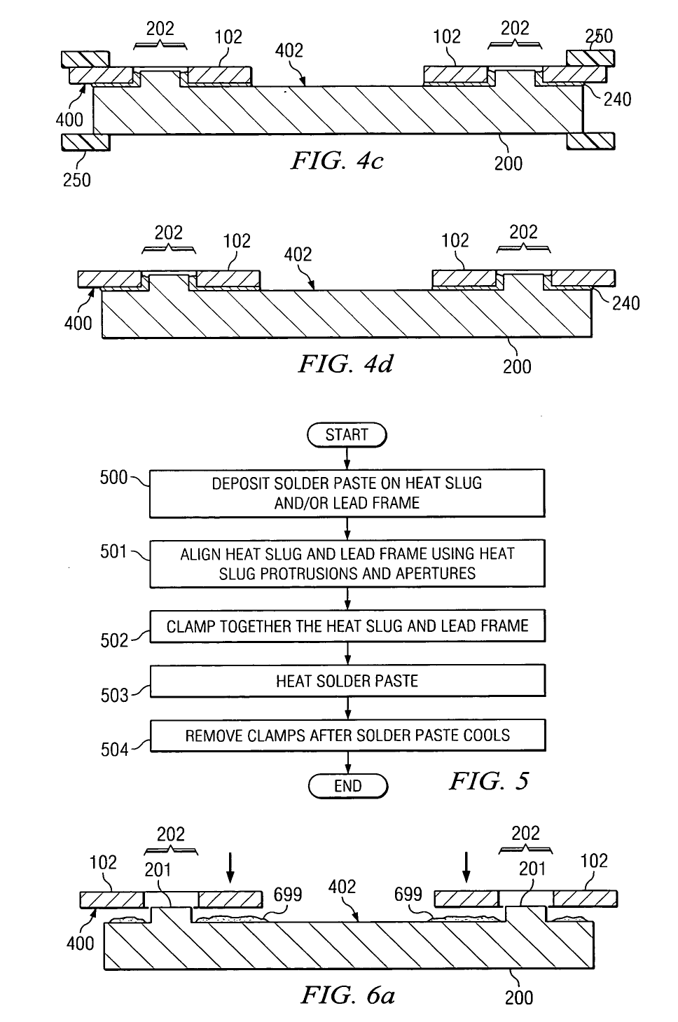

FIGS. 4a-4d show the lead frame 102 being electrically coupled to the heat slug 200 by way of another embodiment of the clamping technique mentioned above. FIG. 5 shows a process that may be used to implement the configurations shown in FIGS. 4a-4d. Referring to FIGS. 4a-4d and 5, the process may begin by printing or otherwise depositing solder paste 240 on at least one of a surface 402 of the heat slug 200 or a surface 400 of the lead frame 102 (block 500), as shown in FIG. 4a. The lead frame 102 then is aligned adjacent the heat slug 200 using the heat slug protrusions 201 and the apertures 202 (block 501), as shown in FIG. 4b. As previously mentioned, the lead frame 102 and the heat slug 200 are aligned to ensure compliance with design specifications. The heat slug protrusions 201 and the apertures 202 preferably are substantially round in shape, although the scope of disclosure is not limited to this shape and comprises rectangular, triangular and other suitable shapes and sizes. The lead frame 102 then is held abutting the heat slug 200 with one or more clamps 250 (block 502), as shown in FIG. 4c. The IC 100 (FIG. 1a) may be coupled to the heat slug 200 using the solder paste. The solder is first heated until molten (block 503). After the solder paste cools and the lead frame 102 is firmly coupled to the heatsink 200, the clamps 250 may be removed (block 504), as shown in FIG. 4d.

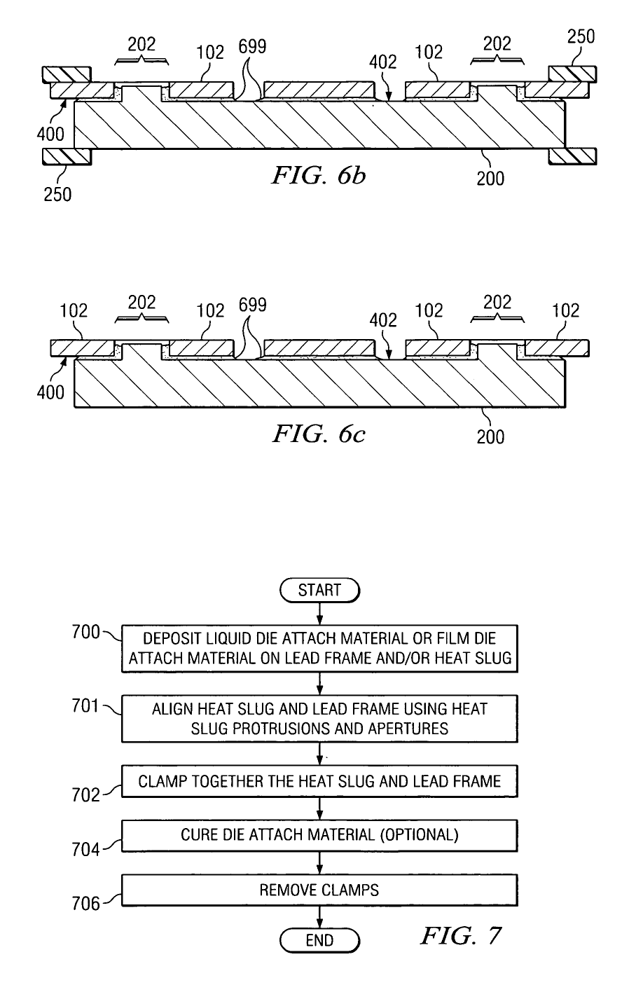

FIGS. 6a-6c show the lead frame 102 being mechanically and/or electrically coupled to the heat slug 200 by way of yet another embodiment of the clamping technique mentioned above. FIG. 7 shows a process that may be used to implement the configurations of FIGS. 6a-6c. Specifically, the process may begin by depositing liquid die attach material 699 or film die attach material 699 on either a surface 400 of the lead frame 102 or a surface 402 of the heat slug 200 (block 700). The lead frame 102 then is aligned with the heat slug 200 using heat slug protrusions 201 and the apertures 202 (block 701), as shown in FIG. 6a. As mentioned above, the heat slug 200 is aligned with the lead frame 102 to ensure proper compliance with design specifications. The heat slug protrusions 201 and/or the apertures 202 may be substantially round, rectangular, or any other suitable shape. The lead frame 102 subsequently is held abutting the heat slug 200 with one or more clamps 250 (block 702), as shown in FIG. 6b. The IC 100 (not shown) optionally may be coupled to the heat slug 200 using the die attach material. As shown in block 704, the die attach material then is optionally cured until dry (e.g., using a curing oven) and then the clamps 250 are removed, as shown in FIG. 6c (block 706). A die also may be coupled to the heatsink 200 during this process.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for coupling a heat slug to a lead frame, comprising:
aligning a heat slug and a lead frame;
depositing a material between the heat slug and the lead frame; and
clamping together the heat slug and the lead frame.

2. The method of claim 1, wherein aligning the heat slug and the lead frame comprises mating a heat slug protrusion to a lead frame aperture.

3. The method of claim 1, wherein depositing the material comprises depositing solder in a lead frame aperture.

4. The method of claim 3, further comprising heating the solder.

5. The method of claim 1, wherein depositing the material comprises depositing solder paste on a surface of at least one of the heat slug or the lead frame.

6. The method of claim 5, further comprising unclamping the heat slug and the lead frame.

7. The method of claim 1, wherein depositing the material comprises depositing on a surface of at least one of the heat slug or the lead frame a die attach material selected from a group consisting of liquid die attach material and film die attach material.

8. The method of claim 7, further comprising curing the die attach material.

9. The method of claim 8, further comprising unclamping the heat slug and the lead frame.

10. The method of claim 1, further comprising coupling an integrated circuit to the heat slug.

11. A semiconductor apparatus, comprising:
a heat slug;
a lead frame adjacent said heat slug;
multiple clamps, each clamp coupled to the heat slug and the lead frame; and
a material sandwiched between the heat slug and the lead frame.

12. The semiconductor apparatus of claim 11, wherein the material is a material selected from a group consisting of solder, solder paste, liquid die attach material and film die attach material.

13. The semiconductor apparatus of claim 11, wherein the heat slug and the lead frame are aligned using a lead frame aperture and a heat slug protrusion.

14. The semiconductor apparatus of claim 13, wherein the heat slug protrusion is substantially of a shape selected from a group consisting of rectangular, circular, and triangular.

15. The semiconductor apparatus of claim 11, further comprising an integrated circuit abutting the heat slug.

16. A method, comprising:
a step for aligning a heat slug and a lead frame;
a step for depositing a material between the heat slug and the lead frame; and
a step for holding together the heat slug and the lead frame.

17. The method of claim 16, wherein the step for depositing the material comprises depositing a material selected from a group comprising solder, solder paste, liquid die attach material and film die attach material.
